(19) United States
(12) Patent Application Publication
(10) Pub. No.: US 2009/0047865 A1
(43) Pub. Date: Feb. 19, 2009

(54) Composite Game System

(75) Inventor: Makoto Nakano, Tokyo (JP)

Correspondence Address: RANKIN, HILL & CLARK LLP, 38210 Glenn Avenue, WILLOUGHBY, OH, 44094-7808, US

(73) Assignee: KONAMI DIGITAL ENTERTAINMENT CO., LTD., Tokyo (JP)

(21) Appl. No.: 12/295,349

(22) PCT Filed: Mar. 30, 2007
(86) PCT No.: PCT/JP2007/057150

§ 371 Date: Sep. 30, 2008

(30) Foreign Application Priority Data
Mar. 30, 2006 (JP) 2006-096052

(51) Int. Cl. A63H 30/04; A63F 13/00

(52) U.S. Cl. 446/456; 463/36

(57) ABSTRACT

A composite game system is provided, in which a controller is common to a game apparatus and a remote-controlled toy, and the remote-controlled toy may easily perform an operation comparable to that of a simulated remote-controlled toy displayed in the game apparatus. Successive commands generated in a game play are stored in first command storage means 14. When the successive commands are supplied through the controller for use in a toy operation, motion capability determination means 16 determines whether or not the successive commands can be used. If the motion capability determination means 16 determines that the successive commands cannot be used, alternative motion command generation means 17 outputs alternative motion commands in which an unusable command is replaced by a usable command.

### TECHNICAL FIELD

The present invention relates to a composite game system in which a game apparatus and a remote-controlled toy may be operated by a common controller.

### BACKGROUND ART

Japanese Patent Application Publication No. 1999-244530 discloses a conventional composite game system in which a game apparatus and a remote-controlled toy are operated by a common controller. In this conventional composite game system, a display screen used to play a game is provided on the controller. Then, according to a result of the game, an operation pattern or operation specification of the remote-controlled toy is changed.

Japanese Patent Application Publication No. 2000-300857 discloses a composite game system in which a TV game and an actual model vehicle are both operated by a controller dedicated to a railway model system that uses a game apparatus for home use.

Further, Japanese Patent Application Publication No. 1997-47575 discloses a composite game system in which capabilities of a toy body, a limb mounted to the toy body, and a toy are recognized by a switch in an identification portion of the toy body, and reflected on display and capabilities of a character in a TV game.

### Patent Document 1: Japanese Patent Application Publication No. 1999-244530 (JP1999-244530A)

### Patent Document 2: Japanese Patent Application Publication No. 2000-300857 (JP2000-300857A)

### Patent Document 3: Japanese Patent Application Publication No. 1997-47575 (JP1997-47575A)

### SUMMARY OF INVENTION

### Technical Problem

In each of the composite game systems described in Patent Documents 1 and 2, the one common controller is used both as a controller for the game apparatus and a controller for operating the remote-controlled toy.

In the conventional composite game systems, however, there is a problem that, since a basic operation of the controller when the game apparatus is operated and a basic operation of the controller when the remote-controlled toy is operated are different, the system is not easy to use.

In the conventional composite game system disclosed in Patent Document 3, the toy body is used as a controller. Accordingly, a simulated toy body may be displayed on a display screen of a game apparatus, and this simulated toy body may perform the same motion as the toy body. However, the toy body cannot perform the same motion as the simulated toy body on the game apparatus.

An object of the present invention is to provide a composite game system in which a controller is common to a game apparatus and a remote-controlled toy, and the remote-controlled toy may easily perform a motion corresponding to that of a simulated remote-controlled toy displayed on the game apparatus.

Another object of the present invention is to provide a composite game system in which a remote-controlled toy may perform a complex motion by a simple operation.

### Solution of Problem

A composite game system of the present invention comprises a game apparatus body, a controller, a display device, a remote-controlled toy, and intercommunication means. The game apparatus body has a built-in computer that executes a game program used to play a game. The controller is provided separately from the game apparatus body. The controller is operated by a player to give the game apparatus body a command corresponding to an operation of the player. The display device is provided at the game apparatus body or is provided separately from the game apparatus body. The remote-controlled toy has a built-in computer that executes an operation program and is operated according to the command from the controller. The intercommunication means allows intercommunication among the controller, the game apparatus body, and the remote-controlled toy, intercommunication between the controller and the game apparatus body, and intercommunication between the controller and the remote-controlled toy.

In the composite game system of the present invention, the computer built in the game apparatus body executes the game program and a simulated remote-controlled toy, which simulates the remote-controlled toy, is operated on the display device in response to the command given to the game apparatus body from the controller in a first play. In this composite game system, the computer built in the remote-controlled toy executes the operation program and the remote-controlled toy is operated in response to the command from the controller in a second play. The first play and the second play are simultaneously or separately performed.

In the present invention, the game program and the operation program are programmed so that a basic operation of the controller is common to the first and second plays. Thereby, when at least one of the first play and the second play is performed, a problem that usability decreases due to an operational difference between the first and second plays will not arise.

The controller of the present invention in particular comprises command storage means, successive command output means, motion capability determination means, and alternative motion command generation means. The command storage means stores certain successive commands obtained by actual operations in the first play. The successive command output means outputs the successive commands stored in the command storage means by performing a simpler operation than operations necessary for outputting the certain successive command in the first play, with the controller in the second play. The motion capability determination means determines whether or not the remote-controlled toy can perform motions corresponding to the successive commands. Then, the alternative motion command generation means generates alternative motion commands in place of the successive commands, the alternative motion commands causing the remote-controlled toy to perform alternative successive motions, when the motion capability determinations means determines that the remote-controlled toy cannot perform the motions corresponding to the successive commands.

When the simulated remote-controlled toy is operated on a display screen of the display device, the simulated remote-controlled toy may perform any motion. However, the actual remote-controlled toy cannot necessarily perform the same motion as the simulated remote-controlled toy on the display screen due to limitations of its material, structure and/or performance. Further, if an operation procedure of the simulated remote-controlled toy on the display screen is not memorized, a player cannot control the remote-controlled toy so that the Remote-controlled toy may perform the same motion as the simulated remote-controlled toy. According to the present invention, the certain successive commands obtained by the actual operations in the first play that operates the simulated remote-controlled toy are stored in the command storage means. Then, by performing the simpler operation with the controller, the successive command output means outputs the successive commands stored in the command storage means. According to the present invention, the operation procedure in the past does not need to be memorized in order to cause the remote-controlled toy to perform the same motion as the simulated remote-controlled toy. In addition, the motion capability determination means determines whether or not the remote-controlled toy may be able to perform the motions corresponding to the successive commands. If the motion capability determination means determines that the remote-controlled toy cannot perform the motions corresponding to the successive commands, the alternative motion command generation means generates the alternative motion commands in place of the successive commands, the alternative motion commands causing the remote-controlled toy to perform the alternative successive motions. The remote-controlled toy may perform a motion that is the same as or similar to the motion of the simulated remote-controlled toy, within motion capability range determined by the performance and the structure of the remote-controlled toy. As a result, the play of the game apparatus and the play of the remote-controlled toy may be merged, and the player's interest in the composite game system may thereby be increased.

Once the remote-controlled toy has performed the motions according to output of the alternative motion commands, a player may misjudge that the motion of the remote-controlled toy has been caused by a control trouble because the motion of the remote-controlled toy is different from the motion of the simulated remote-controlled toy. Then, in order to prevent such a misjudgment, display command generation means should be provided at the game apparatus body or the controller. The display command generation means determines whether or not successive commands that are the same as the successive commands given from the controller are executable in the seccnd play that uses the remote-controlled toy, and outputs a display command to display some indication that the successive commands are not executable in the second play when the display command generation means determines that the successive commands are not executable in the second play. Since the display command generation means is provided, the player may recognize that the remote-controlled toy cannot perform completely the same motion as that of the remote-controlled toy. As a result, the player will not misjudge that the motion of the remote-controlled toy different from that of the simulated remote-controlled toy has been caused by the control trouble. Further, by viewing the indication, the player may confirm motions that the remote-controlled toy can perform within the motion capability range. Accordingly, the player may simulate the remote-controlled toy while viewing the display screen.

In order to cause the simulated remote-controlled toy to perform a motion that is the same as that of the remote-controlled toy during the game, command storage means may be provided at the controller. The command storage means sequentially stores a plurality of commands given to the remote-controlled toy in the second play, and selectively stores these commands as certain successive commands. At the controller, successive command output means may be further provided. The successive command output means outputs the certain successive commands stored in the command storage means by performing a simpler operation than operations necessary for outputting the certain successive commands, with the controller in the first play. With such configuration, the same motion as that of the remote-controlled toy may be reproduced during the game that is played by using the game apparatus body, with the simpler operation using the controller. When the remote-controlled toy of one player competes against the remote-controlled toy of another player, the player may later confirm the operations by checking the motion of the simulated remote-controlled toy on the display screen. Compared with when the player just plays with the remote-controlled toy, the player may be motivated to study on the operation of the remote-controlled toy.

### BRIEF DESCRIPTION OF DRAWINGS

FIG. 1 shows a conceptual configuration of a composite game system in an embodiment of the present invention.

FIG. 2 conceptually shows an operation when a play is performed using a remote-controllable robot as a remote-controlled toy.

FIG. 3 is a block diagram showing function implementation means constituted inside a controller.

FIG. 4 shows an example display on a display device.

FIG. 5 is a flowchart showing an algorithm for a program which is installed in a computer built in a controller and which is used to implement the function implementation means in FIG. 4.

### DESCRIPTION OF EMBODIMENT

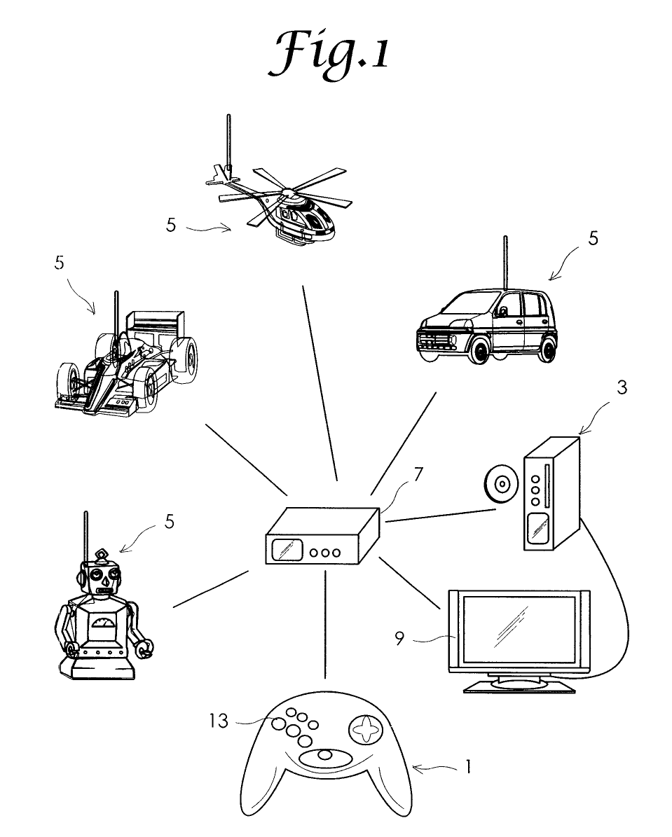

An embodiment of a composite game system of the present invention will now be described below in detail with reference to drawings. FIG. 1 shows a conceptual configuration a composite game system according to one embodiment of the present invention. Referring to FIG. 1, a controller is designated at reference numeral 1. This controller 1 is used both as a controller for a game apparatus body 3 and a controller for a remote-controlled toy (remote control toy) 5. Referring to FIG. 1, intercommunication means is designated at reference numeral 7. This intercommunication means 7 may be provided independently, or may be included inside the game apparatus body 3 or inside the controller 1. Then, the intercommunication means 7, controller 1, game apparatus body 3, and remote-controlled toy 5 are connected to allow communication with or without wires.

The game apparatus body 3 has a built-in computer that executes a game program used to play a game. The controller 1 is provided separately from the game apparatus body 3. The controller 1 is operated by a player to give the game apparatus body 3 or the remote-controlled toy 5 a command corresponding to an operation of the player. Then, a display device 9 is provided separately from the game apparatus body 3, in this embodiment. The display device 9, however, may be of course provided at the game apparatus body 3.

The remote-controlled toy 5 has a built-in computer that executes an operation program and is operated according to the command from the controller 1. The remote-controlled toy therefore corresponds to the so-called remote control toy. Then, the intercommunication means 7 allows intercommunication among the controller 1, the game apparatus body 3, and the remote-controlled toy 5, or intercommunication between the controller 1 and the game apparatus body 3, and intercommunication between the controller 1 and the remote-controlled toy 5.

According to the composite game system, in the first play, the computer built in the game apparatus body 3 executes the game program and a simulated remote-controlled toy (that is actually an image), which simulates the remote-controlled toy 5, is operated on the display device 9 in response to the command given to the game apparatus body 3 from the controller 1. In this embodiment, one remote-controlled toy is controlled by the controller 1. On a display screen of the display device 9 as well, the image of the simulated remote-controlled toy that simulates the one remote-controlled toy 5 is displayed to allow control thereof.

Further, in this composite game system, a second play may be performed simultaneously with or separately from the first play. In the second play, the computer built in the remote-controlled toy 5 executes the operation program and the remote-controlled toy 5 is operated in response to the command from the controller 1. In order to facilitate understanding, it is assumed in the following description that the first play and the second play are selectively executed.

In this embodiment, the game program and the operation program are configured so that a basic operation of the controller 1 is common to the first play that uses the game apparatus body 3 and the second play that operates the remote-controlled toy 5. If at least one of the first play and the second play is performed, a problem with lowered usability due to an operation difference between the first and second plays will not arise.

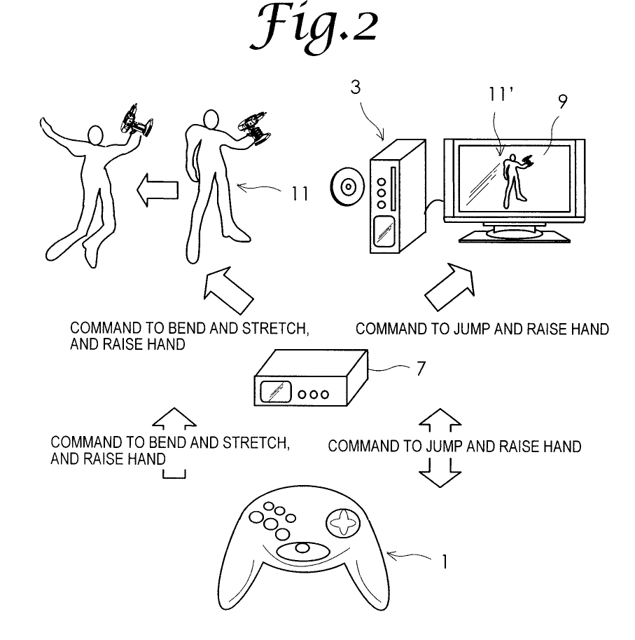

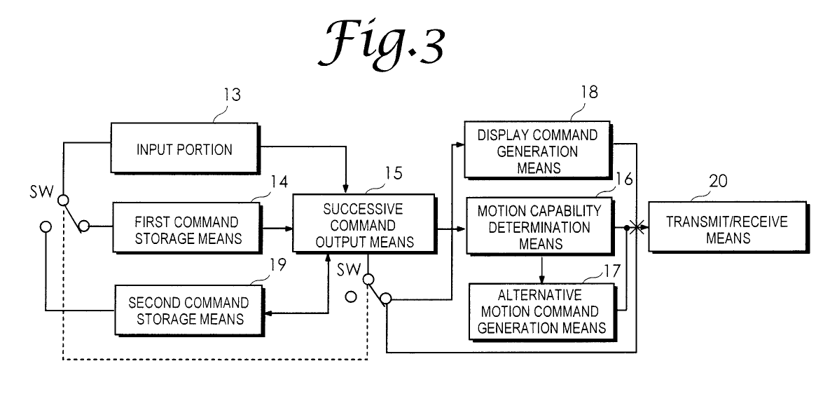

FIG. 2 conceptually shows an operation when a play is performed using a remote-controllable robot 11 as the remote-controlled toy. When a simulated remote-controlled toy 11′ (image of the robot 11) is operated on the display screen of the display device 9, the simulated remote-controlled toy 11′ may perform any motion. However, the actual remote-controlled toy 11 cannot necessarily perform the same motion as the simulated remote-controlled toy 11′ on the display screen, due to limitations of its material, structure, and/or performance. Further, if an operation procedure of the simulated remote-controlled toy 11′ on the display screen 9 is not memorized, the player may not be able to operate the remote-controlled toy 11 to allow the remote-controlled toy 11 to perform the same motion as the simulated remote-controlled toy 11′. Then, in the present invention, certain successive commands obtained by actual operations in a game play that operates the simulated remote-controlled toy 11′ are stored in first command storage means 14 shown in FIG. 3. Then, successive command output means 15 is provided, thereby allowing output of the successive commands stored in the first command storage means 14 by performing a simple operation with the controller 1.

As shown in FIG. 3, in this embodiment, the controller 1 includes an input portion 13, the first command storage means 14, the successive command output means 15, motion capability determination means 16, alternative motion command generation means 17, display command generation means 18, and second command storage means 19. A switch SW operates in response to the play. FIG. 3 shows that the switch SW is switched for performing the first play (game play).

The first command storage means 14 stores the certain successive commands obtained by the actual operations in the game play (first play). Then, the successive command output means 15 is configured to output the successive commands stored in the first command storage means 14 by performing a simpler operation than operations necessary for outputting the certain successive commands to operate the simulated remote-controlled toy 11′ in the game play (first play) with the controller 1, in controlling a toy operation (second play) that operates the remote-controlled toy 11. More specifically, the successive command output means 15 allows output of a series of the successive commands simply by entering a predetermined number through the input portion 13 of the controller 1, for example. In order to allow this operation, when a setting operation stored in an abbreviation form is performed during the play, an abbreviated number is assigned to the successive commands so far stored in the first command storage means 14, and the successive commands are stored as one unit.

The motion capability determination means 16 determines whether or not the remote-controlled toy 11 can perform the motions corresponding to the successive commands. In the motion capability means 16, types of commands and successive command patterns that may be used for controlling over the remote-controlled toy 11 are registered in advance. Assume that successive commands are supplied from the successive command output means 15. Then, if a command other than the usable commands and the usable successive command patterns registered in advance is included in the supplied successive commands, the successive commands are determined as unusable in controlling the toy operation (second play).

If the motion capability determination means 16 determines that the remote-controlled toy 11 cannot perform the operations corresponding to the successive commands, the alternative motion command generation means 17 generates alternative motion commands in place of the successive commands. The alternative motion commands cause the remote-controlled toy 11 to perform alternative successive motions. As the easiest method of generating the alternative motion commands, an unusable command and an unusable command pattern may be removed from the successive commands output from the successive command output means 15, and a series of remaining commands may be generated as the alternative motion commands. A command closely similar to the unusable command may be selected from among usable commands in advance and may be set to an alternative candidate. Then, a command pattern closely similar to the unusable command pattern may be selected from among usable command patterns in advance and may be set to an alternative candidate. If the successive commands may be used without alternation, the motion capability determination means 16 outputs the successive commands to transmit/receive means 20 without alteration. An output of the alternative motion command generation means 17 is also output to the transmit/receive means 20. Assume that the alternative motion command generation means 17 is provided. Then, even if commands to “jump and raise hand” is output in the game play (first play), these commands to “jump and raise hand” cannot be executed in the toy operation (second play), as shown in FIG. 2. When these successive commands are output in the toy operation (second play), the alternative motion command generation means 17 operates to output commands “to bend and stretch, and raise hand” through the controller 1. In this example, the command “to jump” is replaced by the command “to bend and stretch”.

As described above, according to this embodiment, the operation procedure in the past does not need to be memorized in order to cause the remote-controlled toy 11 to perform a motion which is the same as or closely similar to the motion of the simulated remote-controlled toy 11′. In addition, the motion capability determination means 16 determines whether or not the remote-controlled toy 11 can perform motions corresponding to successive commands. If the motion capability determination means 16 determines that remote-controlled toy 11 cannot perform the motions corresponding to the successive commands, the alternative motion command generation means 17 generates the alternative motion commands in place of the successive commands, the alternative motion commands causing the remote-controlled toy 11 to perform the alternative successive motions. The remote-controlled toy 11 may perform a motion that is the same as or similar to the motion of the simulated remote-controlled toy 11′ within a motion capability range determined by the performance and structure of the remote-controlled toy 11.

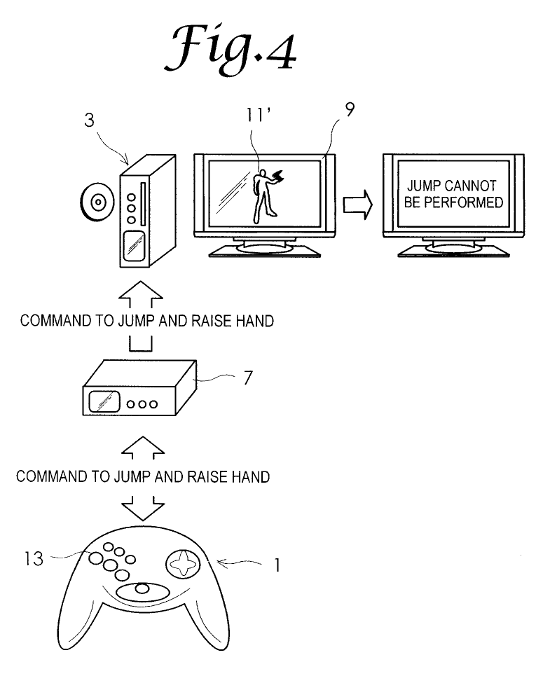

If the remote-controlled toy 11 has been operated according to output of the alternative motion commands, the player may misjudge that the operation of the remote-controlled toy 11 has been caused by a control trouble because the motion of the remote-controlled toy 11 is different from the motion of the simulated remote-controlled toy 11′. Then, in order to prevent such a misjudgment, in this embodiment, the display command generation means 18 is provided at the controller 1. The display command generation means 18 determines whether or not successive commands that are the same as those given from the controller 1 are executable in the toy operation (second play) of the remote-controlled toy 11. If the display command generation means 18 determines that the successive commands are not executable in the second play, the display command generation means 18 outputs a display command to display an indication that the successive commands are not executable in the second play. FIG. 4 shows an example of this display. The example in FIG. 4 shows that an indication that “a jump cannot be performed” is displayed on the screen of the display device 9. Even if the controller 1 outputs a command to bend and stretch during the game play (first play), the remote-controlled toy 11 cannot jump. Thus, the indication described above is displayed. Incidentally, how to display the indication is arbitrary. Then, even if such indication is displayed, the simulated remote-controlled toy 11′ will bend and stretch, and jump in the game play.

When the display command generation means 18 is provided as described above, the player will confirm that the remote-controlled toy 11 cannot perform completely the same motion as the simulated remote-controlled toy 11′. For this reason, the player will not misjudge that the motion of the remote-controlled toy 11 different from that of the simulated remote-controlled toy 11′ has been caused by the control trouble. Further, by viewing the indication, the player may know the motions of the remote-controlled toy 11 that are possible within the motion capability range. Accordingly, the player may simulate a motion of the remote-controlled toy 11 by operating the simulated remote-controlled toy 11′ while viewing the display screen.

Further, in this embodiment, the second command storage means 19 is provided at the controller 1 in order to cause the simulated remote-controlled toy 11′ also to perform the same operations as the remote-controlled toy 11, in the game. The second command storage means 19 sequentially stores a plurality of commands given to the remote-controlled toy 11 during the toy operation (second play) as successive commands. In this situation, the successive command output means 15 is used. By performing a simpler operation than operations necessary for outputting certain successive commands with the controller 1 in the game play (first play), the successive commands stored in the second command storage means 19 may be output. Here as well, an abbreviated operation that stores the successive commands in the second command storage means 19 using an abbreviated number may be performed in a similar manner to that described above. In this embodiment, the same motion as that of the remote-controlled toy 11 may be reproduced without alteration even in the game that uses the game apparatus body 3, with the simpler operation using the controller 1.

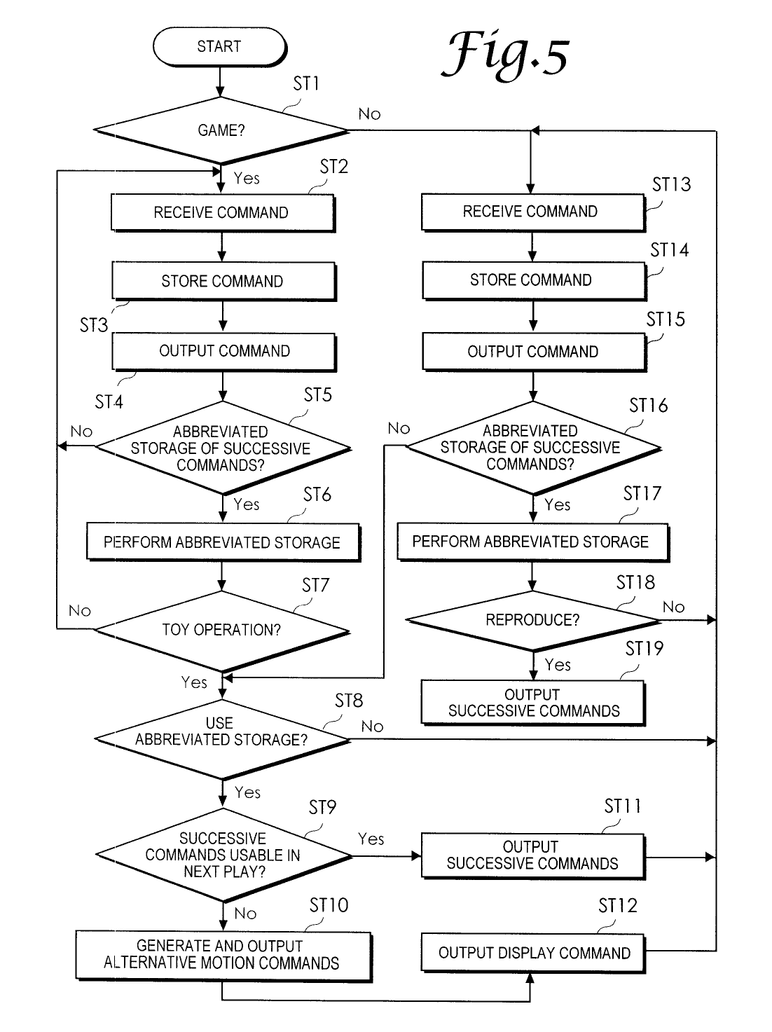

FIG. 5 is a flowchart showing an algorithm for a program which is installed into a computer built in the controller 1 and which is used to implement the function implementation means described above. In this algorithm, after the operation has been started, it is determined in step ST1 whether or not the game play (first play) is to be performed. If the game play is to be performed, the operation proceeds to step ST2, and a command is received through the controller 1. This command is sequentially stored in the first command storage means 14 (in step ST3), and is then output (in step ST4). If a plurality of commands are successively received, these commands are sequentially stored in the first command storage means 14. Then, it is determined in step ST5 whether or not to store in the first command storage means 14 that the successive commands may be output with an abbreviated operation. The abbreviated operation means that the successive commands stored in the first command storage means 14 are output by simply operating a particular operation button using the input portion 13. In step ST6, the successive commands stored in the first command storage means 14 are associated with the simple operation (abbreviated operation) through the input portion 13 and are stored in the first command storage means 14. If the abbreviated operation is not stored, the operation is returned to step ST2. Incidentally, some limitation is provided to successive commands that can be stored in the first command storage means 14. By doing so, the successive commands that are extremely long are prevented from being stored. To be more specific, successive commands constituted by five commands may be stored, for example, and when the number of commands to be stored in the first command storage means 14 equals or exceeds five, the earliest stored command is removed from the command (included in the successive commands) whenever a new command is input. Then, when the abbreviated storage is executed again, storage of another successive commands is resumed.

Next, it is determined in step ST7 whether or not the toy operation (second play) is to be executed or not. If an execution of the toy operation is selected, the operation proceeds to step ST8. Then, it is determined whether or not to use the abbreviated storage. If the use of abbreviated storage is commanded, it is determined in step ST9 whether or not the successive commands stored by the abbreviated storage can be used in the toy operation. If it is determined that the successive commands can be used, the operation proceeds to step ST11. Then, the successive commands are output. If it is determined that the successive commands cannot be used, the operation proceeds to step ST10. Then, alternative motion commands that replace an unusable command by a usable command are output. Then, following this output of the alternative motion commands, a display command is output in step ST12. When the display screen of the display device 9 is in an operation state, an indication that the motion is being performed according to the alternative motion commands is displayed on the display screen. If a similar indication is displayed during the game play, as shown in FIG. 4, a confirmation and display step combining steps ST9 and ST12 may be inserted in a path where the step is returned from step ST7 to step ST2.

If it is determined in step ST1 that the game play is not to be performed, the operation proceeds to step ST13, and a command is received through the controller 1. In the toy operation, when the command is received in step ST13, the command is sequentially stored in the second command storage means 19 in step ST14. Then, in step ST15, the command is output. Then, it is determined in step ST16 whether or not an abbreviated storage of a plurality of commands sequentially stored in the second command storage means 19 should be performed as successive commands. If the abbreviated storage is not performed, the operation proceeds to step ST8, and it is determined whether the successive commands stored in the game play are to be used or not. If it is determined in step ST16 that the abbreviated storage of the successive commands is performed, the abbreviated storage is executed in step ST17. Next, it is determined in step ST18 whether or not a state of the toy operation is to be reproduced (replayed) on the display screen of the display device 9. If the reproduction is not to be performed, the operation is returned to step ST13. If the reproduction is to be performed, the successive commands stored in the second command storage means 19 are output in step ST19. If the display device 9 is in the operation state at that point, the reproduction is performed. The flowchart shown in FIG. 5 does not refer to a finish (end) step. This is because the operation may be finished after any step. So, the finish step is intentionally omitted. The above-mentioned algorithm is an example. The present invention is not limited to the above-mentioned algorithm.

### INDUSTRIAL APPLICABILITY

According to the present invention, the motion capability determination means determines whether or not the remote-controlled toy can perform motions corresponding to successive commands. When it is determined that the remote-controlled toy cannot perform the motions corresponding to the successive commands, the alternative motion command generation means generates alternative motion commands in place of the successive commands, the alternative motion command causing the remote-controlled toy to perform alternative continuous motions. Accordingly, the remote-controlled toy may perform a motion which is the same as or similar to the motion of the simulated remote-controlled toy within the motion capability range determined by the performance, structure, and the like of the remote-controlled toy. As a result, the play of the game apparatus and the play of the remote-controlled toy may be merged. The player's interest in the composite game system may thereby be increased.

1. A composite game system comprising:
a game apparatus body having a built-in computer that executes a game program used to play a game;
a controller provided separately from the game apparatus body, the controller being operated by a player to give the game apparatus body a command corresponding to an operation of the player;
a display device provided at the game apparatus body or provided separately from the game apparatus body;
a remote-controlled toy which has a built-in computer that executes an operation program and is operated according to the command from the controller; and
intercommunication means that allows intercommunication among the controller, the game apparatus body, and the remote-controlled toy, intercommunication between the controller and the game apparatus body, and intercommunication between the controller and the remote-controlled toy;
wherein the computer built in the game apparatus body executes the game program and a simulated remote-controlled toy, which simulates the remote-controlled toy, is operated on the display device in response to the command given to the game apparatus body from the controller in a first play; the computer built in the remote-controlled toy executes the operation program and the remote-controlled toy is operated in response to the command from the controller in a second play; and the first play and the second play are simultaneously or separately performed;
wherein the game program and the operation program are configured so that a basic operation of the controller is common to the first and second plays; and
wherein the controller comprises:
command storage means for storing certain successive commands obtained by actual operations in the first play;
successive command output means for outputting the successive commands stored in the command storage means by performing a simpler operation than operations necessary for outputting the certain successive commands, with the controller in the second play;
motion capability determination means for determining whether or not the remote-controlled toy can perform motions corresponding to the successive commands; and
alternative motion command generation means for generating alternative motion commands in place of the successive commands, the alternative motion commands causing the remote-controlled toy to perform alternative successive motions, when the motion capability determination means determines that the remote-controlled toy cannot perform the motions corresponding to the successive commands.

2. The composite game system according to claim 1, wherein
the game apparatus body or the controller comprises:
display command generation means for determining whether or not successive commands that are the same as the successive commands given from the controller are executable in the second play, and outputting a display command that causes the display device to display that the successive commands are not executable in the second play when the display command generation means determines that the successive commands are not executable in the second play.

3. A composite game system comprising:
a game apparatus body having a built-in computer that executes a game program used to play a game;
a controller provided separately from the game apparatus body, the controller being operated by a player to give the game apparatus body a command corresponding to an operation of the player;
a display device provided at the game apparatus body or provided separately from the game apparatus body;
a remote-controlled toy which has a built-in computer that executes an operation program and is operated according to the command from the controller; and
intercommunication means that allows intercommunication among the controller, the game apparatus body, and the remote-controlled toy, intercommunication between the controller and the game apparatus body, and intercommunication between the controller and the remote-controlled toy;
wherein the computer built in the game apparatus body executes the game program and a simulated remote-controlled toy, which simulates the remote-controlled toy, is operated on the display device in response to the command given to the game apparatus body from the controller in a first play; the computer built in the remote-controlled toy executes the operation program and the remote-controlled toy is operated in response to the command from the controller in a second play; and the first play and the second play are simultaneously or separately performed; and
wherein the controller comprises:
command storage means for storing certain successive commands given to the remote-controlled toy in the second play; and successive command output means for outputting the successive commands stored in the command storage means by performing a simpler operation than operations necessary for outputting the successive commands, with the controller in the first play.
